(19) United States
(12) Patent Application Publication
(10) Pub. No.: US 2004/0132505 A1
(43) Pub. Date: Jul. 8, 2004

(54) Portable radiotelephone

(76) Inventors: Daniel Leclerc, Crissey (FR); Frederic Diximus, Besancon (FR); Ayoub Annabi, Dole (FR)

Correspondence Address: BLANK ROME LLP, 600 NEW HAMPSHIRE AVENUE, N.W., WASHINGTON, DC, 20037, US

(21) Appl. No.: 10/474,804

(22) PCT Filed: Apr. 12, 2002
(86) PCT No.: PCT/FR02/01283

(30) Foreign Application Priority Data
Apr. 13, 2001 (FR) 01/05092
Apr. 13, 2001 (FR) 01/05093

(51) Int. Cl. H04M 1/00; H04M 9/00

(52) U.S. Cl. 455/575.1; 379/419

(57) ABSTRACT

The invention provides a mobile radiotelephone comprising a casing, a printed circuit card placed inside the casing (30), and an antenna constituted by a radiating conductive element (44) and by a ground plane (50). The radiotelephone is characterized in that the radiating conductive element (44) is disposed outside the casing (30), is mechanically connected thereto, and extends substantially parallel to the printed circuit card. The printed circuit card (42) carries means forming a ground plane (50). The distance h between the radiating conductive element (44) and the printed circuit card (42) lies in the range 7 mm to 15 mm. The radiating conductive element is embedded in an insulating piece (44) mechanically connected to the housing and presenting sufficient mechanical strength to constitute a fastener system for the radiotelephone.

The present invention relates to a portable radiotelephone including an antenna.

A portable radiotelephone naturally needs to be fitted with an antenna in order to enable it to receive and transmit electromagnetic waves for conveying information. The antenna may be of various types. For example, it may be a removable whip antenna which is thus constituted by a rectilinear conductive element. It may also be a helically-shaped antenna placed permanently on the outside of the radiotelephone casing. Finally, it may be a patch type antenna.

Whether it is a patch antenna or an antenna having an elongate radiating element, it is necessary to provide a ground plane.

In PCT patent application No. WO 99/57785 filed in the name of the Applicant, a patch type antenna is described together with its possible use in a portable radiotelephone.

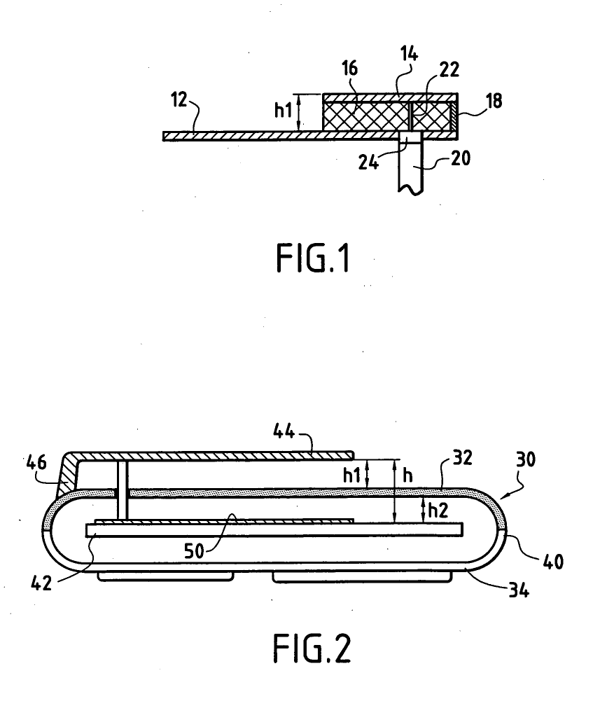

For a better understanding of the present invention and the problems that it serves to resolve, there follows a brief summary with reference to accompanying FIG. 1 of the organization and the structure of such a patch antenna of the type described in the above-specified patent application.

FIG. 1 shows the antenna ground plane 12 constituted by a conductive plate, the radiating plate 14 of the antenna, a piece of dielectric material 16 interposed between the ground plane 12 and the radiating plate 14, and a short-circuit 18 which connects the radiating plate 14 to the ground plane 12 along one side only of the piece 16 which is generally in the form of a rectangular parallelepiped. The signal is fed to the antenna or is recovered from the antenna by an antenna conductor 20 essentially constituted by a coaxial cable whose core 22 is electrically connected to the radiating plate 14 and whose peripheral conductor 24 is connected to the ground plane 12.

By giving the radiating plate 14 suitable dimensions, it is possible to tune the antenna on two frequency bands corresponding to the two main radiotelephone systems currently in operation, namely the GSM system whose center of frequency is about 920 megahertz (MHz) and the DCS system whose center frequency is about 1800 MHz.

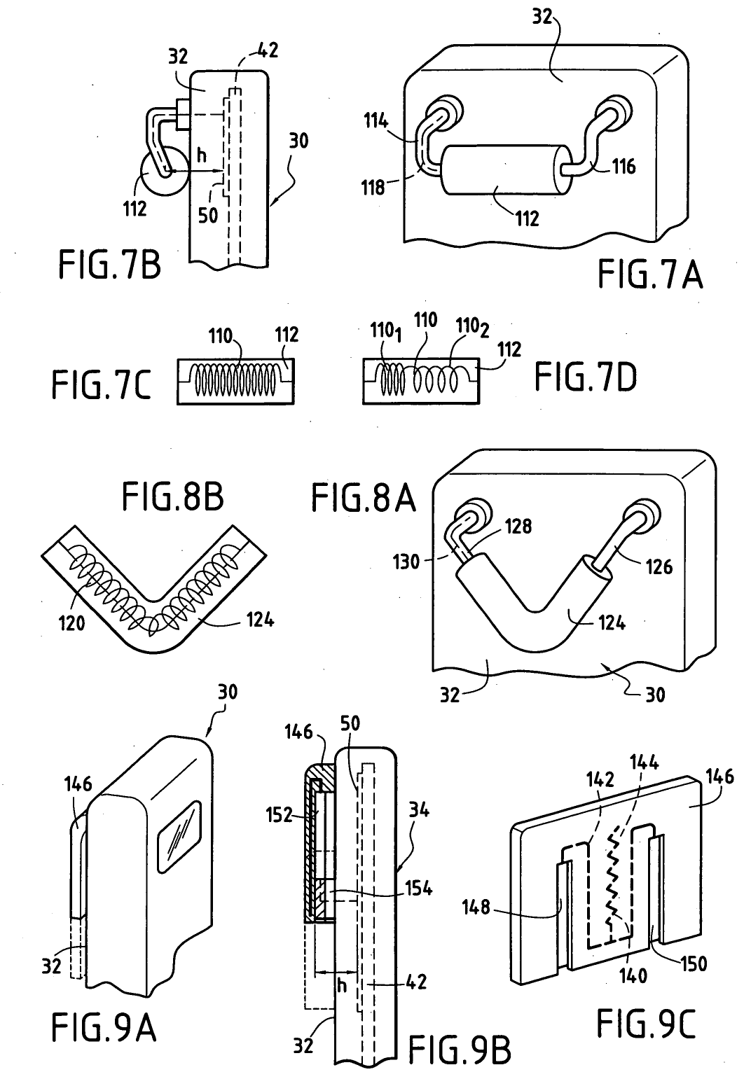

In a preferred embodiment, the block of dielectric material 16 is constituted by a ceramic presenting relative permittivity of about 6 and a loss angle whose tangent is equal to 10⁻⁴. By using such a dielectric material, is it possible to make provision for the distance h1 between the ground plane 12 and the radiating plate 14 to be about 4 millimeters (mm) to 5 mm. Having a patch antenna assembly of such small thickness makes it easy to integrate the assembly in the casing of the radiotelephone, as shown in FIG. 7 of the above-specified PCT patent application.

However, in present developments of radiotelephones, it is desirable firstly to reduce manufacturing costs, and thus the cost of fabricating each of its basic components and in particular its antenna, and also, and above all, it is desirable to reduce the total weight of the radiotelephone, and thus in particular the total weight of the antenna. Unfortunately, the relative weight of the block of ceramic material 16 is not negligible, which goes in the opposite direction to that desired.

Naturally, one solution to that problem consists in using a simple sheet of air as the dielectric material, thus making it possible to omit the weight of the block of ceramic material. However, such a solution is difficult to use in a portable radiotelephone since when air constitutes the dielectric, it is necessary for the distance h1 between the ground plane 12 and the radiating plate 14 to be increased very considerably. This increase in distance makes it very difficult to house the patch antenna inside the casing of the radiotelephone since the present trend is also for the external dimensions of the casing of such an appliance to be made smaller.

In addition, the casing of the radiotelephone usually needs to be fitted with a mechanical fastener system, e.g. for clipping to the belt of the user.

An object of the present invention is to provide a portable radiotelephone which has a patch type antenna or a wire type antenna, and that is of reduced weight, while remaining compatible with the small dimensions of the casing of a portable radiotelephone fitted with fastener means.

To achieve this object, the invention provides a mobile radiotelephone comprising a casing, a printed circuit card placed inside the casing, and an antenna constituted by a radiating conductive element and by a ground plane, the radiotelephone being characterized in that: said radiating conductive element is disposed outside said casing, is mechanically connected thereto, and extends substantially parallel to said printed circuit card; said printed circuit card has means forming a ground plane; the distance h between said radiating conductive element and said printed circuit card lies in the range 7 mm to 15 mm; and said radiating conductive element is disposed inside an insulating piece that is mechanically connected to said casing and that presents sufficient mechanical strength to constitute a fastener system for said radiotelephone.

In a first embodiment, the radiotelephone is characterized in that said radiating conductive element is a conductive plate substantially parallel to said printed circuit card and facing it to form a patch antenna, and in that said distance h lies in the range 7 mm to 12 mm. The antenna is thus a patch type antenna.

In a second embodiment, said radiating conductive element is elongate in shape and said distance h lies in the range 10 mm to 15 mm.

Other characteristics and advantages of the invention appear better on reading the following description of various embodiments of the invention given as non-limiting examples. The description refers to the accompanying figures, in which:

FIG. 1, described above, shows the structure of a prior art patch antenna;

FIG. 2 is a simplified longitudinal section view of a portable radiotelephone fitted with a patch antenna constituting a first embodiment of the invention;

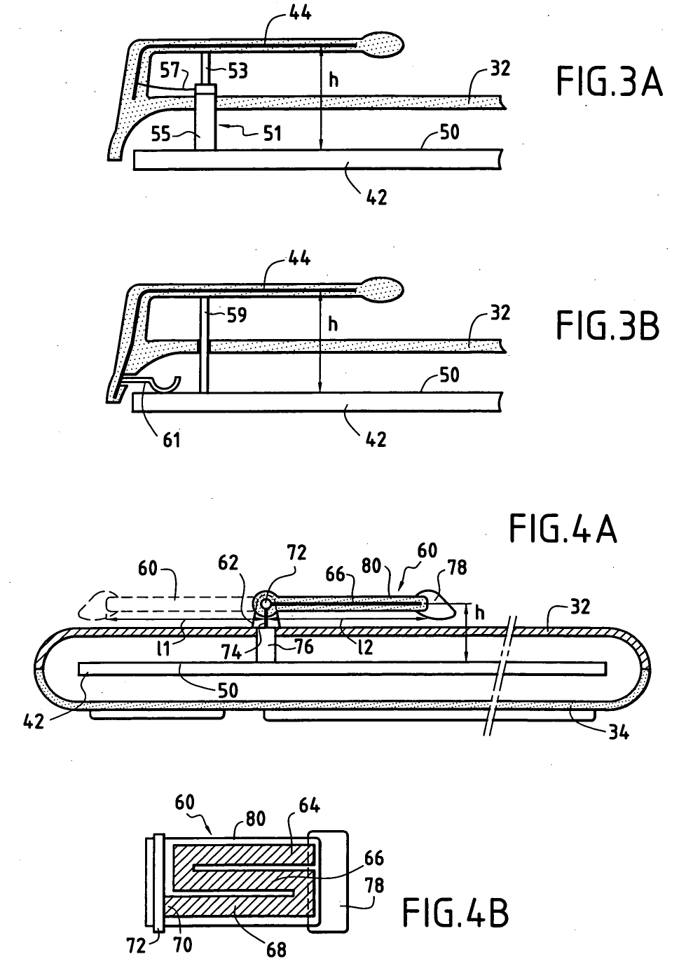

FIGS. 3A and 3B show two particular structures for the FIG. 2 radiotelephone;

FIGS. 4A and 4B are respectively a longitudinal section view and a fragmentary plan view of a preferred embodiment of the radiating plate;

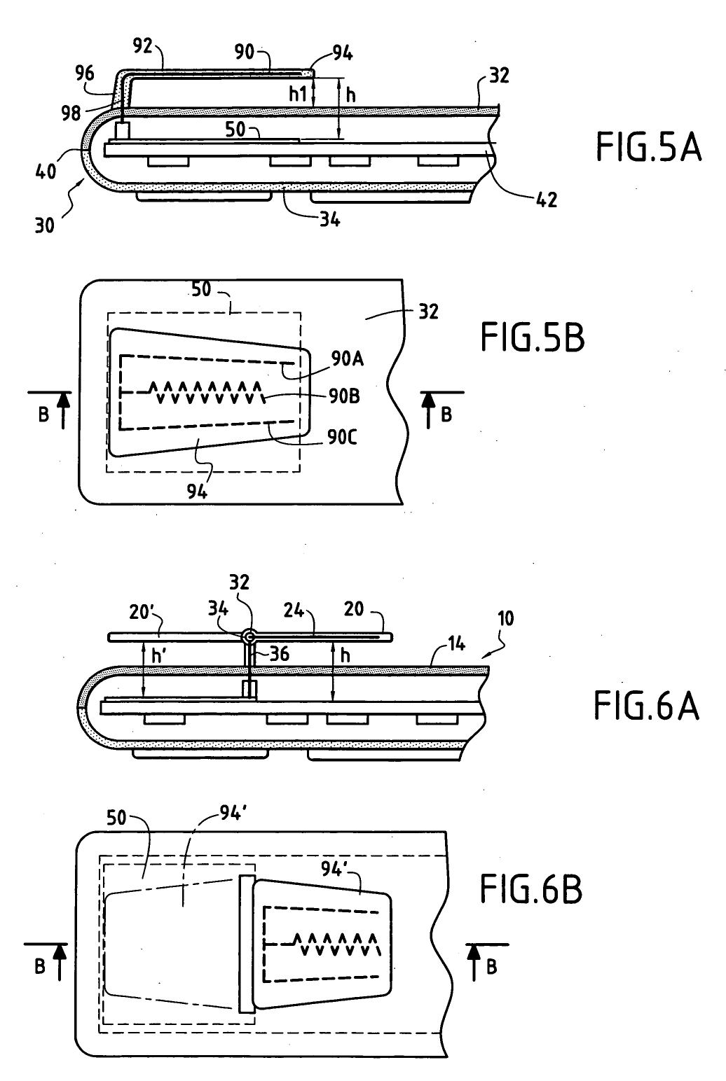

FIG. 5A is a plan view of a radiotelephone constituting a second embodiment of the invention;

FIG. 5B is a section view on line B-B of FIG. 5A;

FIG. 6A is a plan view of a first variant of the second embodiment;

FIG. 6B is a longitudinal section view on line B-B of FIG. 6A;

FIGS. 7A and 7B are a front view and a side view of a second variant of the second embodiment of the radiotelephone;

FIGS. 7C and 7D are detail views showing two possible antenna shapes;

FIG. 8A is an elevation view showing a third variant of the second embodiment of the invention;

FIG. 8B is a detail view showing a possible shape for the antenna;

FIGS. 9A and 9B are a perspective view and a side view of a fourth variant of the second embodiment of the invention; and

FIG. 9C is a detail view showing a possible shape for the antenna.

With reference initially to FIG. 2, a preferred embodiment of the radiotelephone is described for a radiotelephone fitted with a patch antenna in accordance with the invention.

This figure shows the casing 30 of the radiotelephone having a posterior face 32, an anterior face 34 provided with a keypad 36 and/or a microphone or an earpiece 38, and having an end face 40. The casing is made of insulating material. Inside the casing, there is shown only the printed circuit card 42 which carries the various electronic components of the radiotelephone together with conductive tracks connecting them together and shielding. In this embodiment, the patch antenna is constituted by an external plate 44 of rectangular shape, for example, and on which a particular pattern can be created, being made out of a conductive material, for example a conducive plastics material or a metal plate embedded in an insulating material in order to obtain satisfactory mechanical strength. The plate is mechanically connected by the element 46 to the casing in such a manner that the plate 44 extends parallel to the posterior wall 32 of the casing and to the printed circuit card 42. The plate 44 forms the radiating plate or radiating element of the patch antenna.

A distance h1 is provided between the plate 44 and the posterior wall of the casing. The printed circuit 42 which supports the electronic elements of the radiotelephone also has a zone 50 that is metallized at least in part, at least where it faces the plate 44. This zone is physically located in the printed circuit card which is usually of the multilayer type. Thus, the printed circuit 42 constitutes the ground plane of the patch antenna, with the plate 44 constituting the radiating plate.

The antenna conductor 52 may be constituted by a coaxial cable whose central core is electrically connected to the plate 44 and whose peripheral conductor element 56 is connected to the metallized zone 50 of the printed circuit. In this embodiment, there is no short-circuit between the ground plane and the radiating element 44. In this case, if the distance between the printed circuit 42 and the posterior wall 32 of the casing is written h2, then the thickness of the dielectric constituted by the air between the radiating plate 44 and the printed circuit 42 (referenced h in the figure) is naturally equal to h1+h2. The distance h2 may be determined by the construction of the radiotelephone, whereas the distance h1 can be adapted so as to obtain a value for h that lies in the range 7 mm to 12 mm. This distance enables the plate 44 together with its mechanical support to act as a fastener system for the radiotelephone.

FIGS. 3A and 3B show two particular constructions for the antenna conductor.

In FIG. 3A, the antenna conductor is constituted by a coaxial cable 51 constituted by an axial conductor 53 connected to the radiating plate 44′ and shielding 55 which is preferably bare. The short-circuit between the radiating plate 44′ and the ground plane 50 is preferably made by a resilient electrical contact 57 soldered to the extension of the radiating plate 44′ and in contact with the shielding 55.

In the embodiment of FIG. 3B, the antenna conductor is constituted by a single electrical conductor 59. The short-circuit between the ground plane 50 and the radiating plate 44± consists in a resilient electrical contact 61 soldered to the portion 50 of the printed circuit that forms the ground plane and in electrical contact with the extension of the plate 44 through a window 63 made through the insulating material.

Advantageously, the radiating plate 44 can be made by being embedded in a plastics material so that the radiating plate simultaneously constitutes a mechanical fastener or clip system for securing the radiotelephone to the belt of its user, for example.

It will thus be understood that whichever embodiment is used, it is possible to obtain a dielectric value that is sufficient to ensure good operation of the antenna without increasing the thickness of the radiotelephone casing 30. In addition, the radiating plate can also constitute a fastener or clip system of the kind generally provided on radiotelephones.

With reference to FIGS. 4A and 4B, there follows a description of a variant of the radiotelephone shown in FIG. 2. In these figures, there can be seen the casing 30, the printed circuit 42 including the means forming a ground plane, and the anterior wall 34. In this variant, the plate forming the radiating plate 60 is pivotally mounted relative to the fastener piece 62 on the posterior wall 32 of the casing. As can be seen more clearly in FIG. 4B, the conductive plate is of a special shape made up of three interconnected parallel elements referenced 64, 66, and 68, together providing a total length corresponding to the frequency range or ranges used for conveying information. The connection end 70 of the conductor is connected, for example, to a conductive pivot pin 72 itself connected to a conductive element 74 embedded in the fastener piece 62. The conductive element 74 forms the center conductor of the antenna coaxial cable 76 whose outer conductor is electrically connected to the conductive rear wall 32 of the casing. The metal plate proper is preferably embedded in a piece of plastics material 80 whose end projects beyond the conducive plate in order to form a curved end 78 that improves the clipping effect of the plate 60. The length l2 of the conductive plate is substantially equal to the length l1 of the portion of the conductive posterior wall 32 of the casing that extends beyond the fastener piece 62.

While the radiotelephone is not in use, the piece 60 is in the position shown in FIG. 4A and it can therefore act as a mechanical fastening or clipping system for the radiotelephone, for example for engaging the belt of the user. In contrast, while it is in use, the piece 60 is pivoted through 180° so as to occupy the position shown in dashed lines in the figure, i.e. so that it overlies a portion of the conductive rear wall. With the piece in this position, the user finds the radiotelephone easier to hold while it is in use, and the patch antenna constituted by the pivoted element 60 co-operating with the conductive posterior wall 32 presents the required qualities since these two elements of the patch antenna are facing each other.

Naturally, this embodiment could be obtained starting from that of FIG. 3, i.e. the posterior wall of the casing could be insulating, with the printed circuit 42 then acting as the ground plane as explained with reference to FIG. 3.

With reference to FIGS. 5A and 5B, there follows a description of a second embodiment where the radiotelephone is fitted with a wire type antenna, i.e. an antenna having a radiating element of elongate shape.

In these figures, there can be seen the casing 30 of the radiotelephone together with its anterior wall 34, its posterior wall 32, and its end wall 40 which are made of an electrically insulating material, usually a plastics material. Inside the housing there can be seen in particular a printed circuit card 42 which carries the various electronic components of the radiotelephone and naturally the conductor tracks for interconnecting these various components. As a general rule, the printed circuit is of the multilayer type and thus has a very large number of conductive tracks together with conductive deposits constituting electrical shielding for eliminating interfering radiation. This printed circuit card with its metallization constitutes a ground plane for the antenna.

The radiotelephone also has one or more antennas given general reference 90 which are made on an insulating support 92, these antennas, e.g. 90A, 90B, and 90C are constituted by conductive deposits made on the insulating support 92. Each antenna is of a shape that corresponds to a frequency band in which the radiotelephone is to operate. The antennas are preferably embedded in a piece of insulating plastics material 94 which extends parallel to the posterior face 32 of the radiotelephone casing. The piece 94 is connected to the posterior wall 32 of the casing by a fastener element 96 of insulating material. The antennas 90 are electrically connected to the printed circuit 42 by a conductive element 98 embedded in the element 96.

As already mentioned, the printed circuit 42 has a large amount of metallization such that, at least in the zone 50 facing the wire antennas 90, the printed circuit acts overall as a ground plane for the antennas 90. The piece 94 is placed at a distance h1 from the posterior wall of the casing 32 in such a manner that the distance between the printed circuit 42 and the piece 94 carrying the antennas is equal to h, where said distance h is not less than 10 mm and is less than 15 mm. This distance must be complied with to ensure that the ground plane 50 does not disturb the operation of the antenna. In addition, the ground plane constitutes a reflecting surface for protecting the user against electromagnetic waves.

It will be understood that in the configuration shown in FIGS. 5A and 5B, the piece 94 acts as a mechanical clip, e.g. for engaging the belt of the user.

It should be emphasized that in this second embodiment, the ground plane 50 is constituted by the printed circuit, which is advantageous, economically speaking. Nevertheless, the presence of this ground plane facing the wire antenna that forms the radiating element does not disturb the operation of the antenna because of the distance h between these two elements which distance preferably lies in the range 10 mm to 15 mm. Nevertheless, it should be observed that for a distance h lying in the range 7 mm to 10 mm, the antenna still functions, but in less satisfactory manner.

A first variant of the second embodiment of the radiotelephone is described below with reference to FIGS. 6A and 6B. In this variant embodiment, the piece 94′ similar to the piece 94 in FIG. 5 has the antennas 90 inside it. This piece is mounted to pivot about a pin 102 parallel to the posterior wall 32 of the casing. A pivoting contact 104 enables the antennas of the piece 94′ to be connected to the antenna conductor 96. In this variant, the piece 94′ may be in a rest position shown in continuous lines in FIG. 6B or in an operating position shown in dashed lines in FIG. 6B. It will be understood that in the operating position, the antennas 90 face the ground plane 50 constituted by at least a portion of the printed circuit 42. Naturally, in this case also, the distance h′ between the printed circuit and the piece 94′ is not less than 10 mm. In the operating position, the antenna uncovers a larger fraction of the casing so as to make it easier for the user to hold.

A second variant of the second embodiment of the radiotelephone is described below with reference to FIGS. 7A to 7C. In this variant, the antenna is constituted by a conductive wire element 110 that is in the form of a helix which is preferably embedded in a piece of insulating plastics material 112. The piece 112 is secured to two bent arms 114 and 116 whose ends are secured to the posterior face of the casing 32. One of the arms, e.g. the arm 114, includes a conductive element 118 for connecting one end of the antenna 110 to the printed circuit 42 of the radiotelephone. In this case also, the antenna 110 (or more precisely its axis) is situated at the distance h of not less than 10 mm from the ground plane 50 constituted by the circuit 42. In addition, this constitutes a surface for reflecting electromagnetic waves and it is situated facing the antenna-constituting coil 110. This serves to protect the user. It will also be understood that in this variant, the assembly constituted by the piece 112 and by the arms 114 and 116 advantageously constitutes a fastener system for engaging the radiotelephone on the belt of the user, for example.

As shown in FIG. 7D, in a variant, the antenna 110 may be constituted by a helix presenting a first portion 110₁ at a first pitch and a second portion 110₂ having a second pitch that is different.

A variant of the embodiment of FIGS. 7A to 7D is shown in FIGS. 8A and 8B. In this variant, the antenna 120 is still constituted by a helix, but the mean line of the helix forms a V-shape. The antenna assembly 120 is embedded in a piece of insulating plastics material 124 that is likewise V-shaped. As in the above-described embodiment, the piece 124 is connected by arms 126 and 128 to the posterior face 32 of the radiotelephone casing. In this case also, the assembly constituted by the piece 124 and the arms 126 and 128 advantageously constitutes a mechanical fastener system for the radiotelephone. Naturally, one of the arms, e.g. the arm 128, includes a conductive element 130 for connecting one end of the antenna 120 to the printed circuit of the radiotelephone. The ground plane 50 facing the radiating element or antenna 120 also constitutes a reflector for protecting the user. The distance between the antenna 120 and the ground plane 50 lies in the range 10 mm to 15 mm so as to avoid disturbing the operation of the antenna.

FIGS. 9A to 9C show a variant of the embodiment shown in FIGS. 6A and 6B. In this variant, the antenna is likewise movable relative to the casing 30 of the radiotelephone, but it is movable in translation instead of in rotation. The antenna(s) 140, 142 is/are preferably made by depositing conductive material on an insulating medium 144, e.g. made of flexible polyester. The insulating medium 144 is itself embedded in a mechanical piece 146 which has means for guiding it in translation, for example slots 148 and 150 provided with lateral grooves such as 152. The posterior face 32 of the radiotelephone casing carries two T-shaped pieces such as 154 suitable for co-operating mechanically with the slots 148 and 150 provided with their lateral grooves 152. By means of this disposition, the piece 146 can occupy a rest position shown in continuous lines in FIG. 9B and an in-use position shown in dashed lines in the same figure. When the piece 146 containing the antennas is in its in-use position, the antennas 142 and 144 are located facing the ground plane 50 formed by the printed circuit 42. In addition, the guide pieces 154 are made in such a manner that the distance between the antennas and the ground plane 50 is equal to h and is not less than 10 mm. The guide pieces 154 preferably include an internal conductor element 156 for connecting the antennas 140 and 142 to the printed circuit 42, regardless of the position occupied by the antenna piece 146.

1. A mobile radiotelephone comprising a casing, a printed circuit card placed inside the casing, and an antenna constituted by a radiating conductive element and by a ground plane, the radiotelephone being characterized in that:
said radiating conductive element is disposed outside said casing, is mechanically connected thereto, and extends substantially parallel to said printed circuit card;
said printed circuit card has means forming a ground plane;
the distance h between said radiating conductive element and said printed circuit card lies in the range 7 mm to 15 mm; and
said radiating conductive element is disposed inside an insulating piece that is mechanically connected to said casing and that presents sufficient mechanical strength to constitute a fastener system for said radiotelephone.

2. A radiotelephone according to claim 1, characterized in that said radiating conductive element is a conductive plate substantially parallel to said printed circuit card and facing it to form a patch antenna, and in that said distance h lies in the range 7 mm to 12 mm.

3. A radiotelephone according to claim 2, characterized in that said insulating piece is pivotally mounted about an axis parallel to said plane conductive element.

4. A radiotelephone according to claim 2 or claim 3, characterized in that said antenna does not have a short-circuit between the ground plane and the radiating plate.

5. A radiotelephone according to claim 2 or claim 3, characterized in that said patch antenna further comprises short-circuit forming means between the ground plane and the radiating plate.

6. A radiotelephone according to claim 1, characterized in that said radiating conductive element is elongate in shape and said distance h lies in the range 10 mm to 15 mm.

7. A radiotelephone according to claim 6, characterized in that said element of elongate shape is constituted by at least one electrically conductive wire element made on an insulating support mechanically connected to said posterior wall of the casing by link means.

8. A radiotelephone according to claim 6, characterized in that said element of elongate shape is constituted by a wire conductor element of generally helical shape having its axis substantially parallel to the posterior wall of the casing, said helix being embedded in a piece of insulating material that is mechanically connected to said posterior wall by fastener means.
